(19) United States
(12) Patent Application Publication
(10) Pub. No.: US 2011/0035514 A1
(43) Pub. Date: Feb. 10, 2011

(54) INFORMATION TRANSMISSION APPARATUS

(75) Inventors: Takayuki Tachikawa, Hamura-shi (JP); Takeshi Daiku, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/837,397

(22) Filed: Jul. 15, 2010

(30) Foreign Application Priority Data
Aug. 5, 2009 (JP) 2009-182699

(51) Int. Cl. G06F 13/10

(52) U.S. Cl. 710/19

(57) ABSTRACT

According to one embodiment, an information transmission apparatus includes a connection module, a detector, an output module, and a transmitter. The connection module is configured to connect at least one external device. The detector is configured to detect a status of at least one content compatible with the at least one external device connected by the connection module. The output module is configured to output display information for display a connection state with at least one compatible external device compatible with the at least one content having the status, the at least one compatible external device included in the at least one external device connected by the connection module. The transmitter is configured to transmit a selected content to the at least one compatible external device displayed based on the display information.

### CROSS-REFERENCE TO RELATED APPLICATIONS

This application is based upon and claims the benefit of priority from Japanese Patent Application No. 2009-182699, filed Aug. 5, 2009; the entire contents of which are incorporated herein by reference.

### FIELD

Embodiments described herein relate generally to an information transmission technique of, e.g., content.

### BACKGROUND

In recent years, a recording/playback apparatus which can record and play back digital television broadcast content has prevailed. This recording/playback apparatus records digital television broadcast content using a hard disk drive (HDD) and Digital Versatile Disk (DVD). The storage capacities of information storage media such as hard disks and optical disks are increasing year by year. For this reason, a recording/playback apparatus and a television receiver with a recording function using these information storage media can record a large number of programs.

However, since the storage capacity of each information storage medium is limited, the storage capacity may often become short as programs are recorded. Hence, a recording/playback apparatus and television receiver with a recording function, which can expand external storage devices, appear.

Under such circumstances, Jpn. Pat. Appln. KOKAI Publication No. 2006-18871 (reference 1) discloses a recording/playback apparatus which allows the user to easily execute content copy operations between apparatuses with high operability. This recording/playback apparatus establishes connection to another recording/playback apparatus via a network, and checks based on information associated with recording media held by the other recording/playback apparatus and information associated with a status of the other recording/playback apparatus whether the other recording/playback apparatus is established as a copy destination.

The recording/playback apparatus disclosed in reference 1 above checks based on the status of a connected partner device whether that device is established as a copy destination. However, in recent years, encrypted content (copyright-protected content) has been provided in terms of copyright protection. Such copyright-protected content is not always played back by every recording/playback apparatuses. That is, an external storage device compatible with a content is decided according to the status of that content. The aforementioned recording/playback apparatus does not detect a status of a content with which the connected partner device is compatible. Therefore, when the connected partner device receives an incompatible content, that partner device cannot appropriately play back the received content.

For example, assume that a plurality of external storage devices are connected to one recording/playback apparatus. In this case, a general user cannot easily detect an external storage device compatible with a content stored in this recording/playback apparatus. For this reason, the user may often select an external storage device which cannot appropriately play back the content as a transmission destination. In this way, it is difficult to select a proper transmission destination according to the status of a content.

### BRIEF DESCRIPTION OF THE DRAWINGS

A general architecture that implements the various features of the invention will now be described with reference to the drawings. The drawings and the associated descriptions are provided to illustrate embodiments and not to limit the scope of the invention.

FIG. 1 is a view for explaining an example of narrow-down display of storage devices suited to transmission destinations of a content;

FIG. 2 is a view for explaining an example of ProfileName confirmation processing before content transfer;

FIG. 3 is a view for explaining an example of guarantee of copy/move device selection;

FIG. 4 is a flowchart for explaining an example of storage device list creation processing;

FIG. 5 is a flowchart for explaining an example of selection processing of a suited storage device;

FIG. 6 is a flowchart for explaining an example of a case in which the user selects a storage device, and then selects a content;

FIG. 7 is a flowchart for explaining an example of a case in which the user selects a content, and then selects a storage device;

FIG. 8 is a schematic block diagram showing the arrangement of a video recording/playback apparatus (information transmission apparatus) according to an embodiment of the invention; and

FIG. 9 is a view for explaining an example of “ProfileName”.

### DETAILED DESCRIPTION

Various embodiments will be described hereinafter with reference to the accompanying drawings.

In general, according to one embodiment, an information transmission apparatus includes a connection module, a detector, an output module, and a transmitter. The connection module is configured to connect at least one external device. The detector is configured to detect a status of at least one content compatible with the at least one external device connected by the connection module. The output module is configured to output display information for display a connection state with at least one compatible external device compatible with the at least one content having the status, the at least one compatible external device included in the at least one external device connected by the connection module. The transmitter is configured to transmit a selected content to the at least one compatible external device displayed based on the display information.

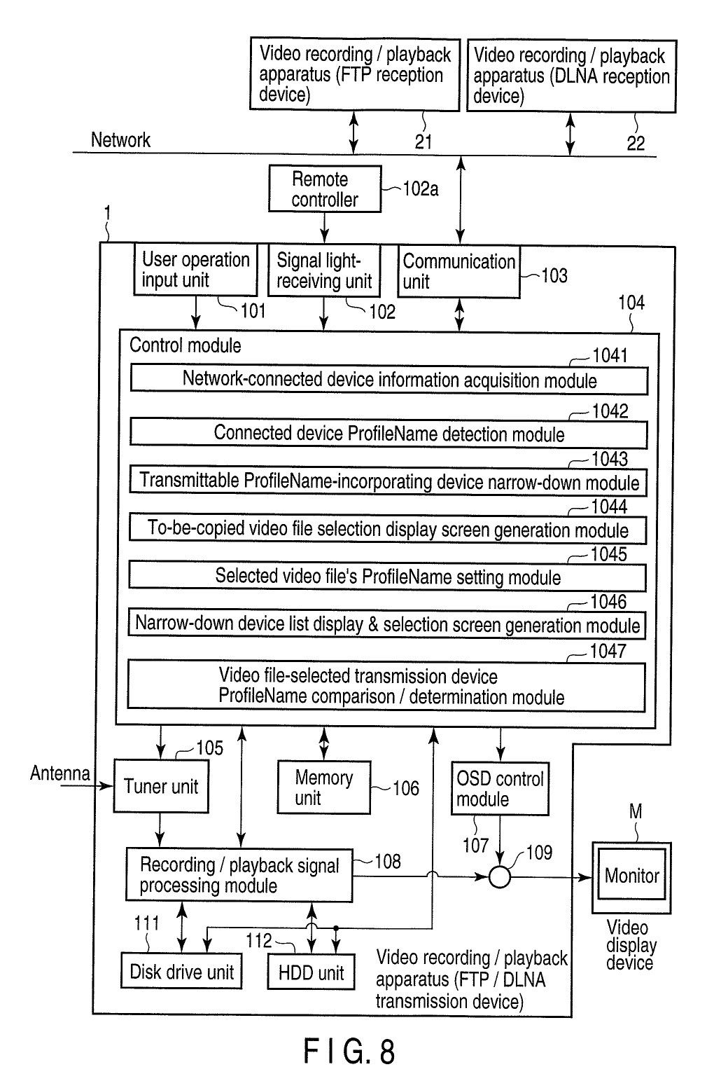

FIG. 8 is a schematic block diagram showing the arrangement of a video recording/playback apparatus (information transmission apparatus) according to an embodiment.

As shown in FIG. 8, a video recording/playback apparatus 1 (FTP/DLNA transmission device) includes a user operation input unit 101, signal light-receiving unit 102, communication unit 103, control module 104, tuner unit 105, memory unit 106, OSD control module 107, recording/playback signal processing module 108, composition processing module 109, disk drive unit 111, and HDD unit 112.

Furthermore, the control module 104 includes a network-connected device information acquisition module 1041, connected device ProfileName detection module 1042, transmittable ProfileName-incorporating device narrow-down module 1043, to-be-copied video file selection display screen generation module 1044, selected video file's ProfileName setting module 1045, narrow-down device list display & selection screen generation module 1046, and video file-selected transmission device ProfileName comparison/determination module 1047.

The communication unit 103 is connected to one or more external devices via a network, can transmit information to the external devices, and can receive information transmitted from the external devices. For example, as shown in FIG. 8, the communication unit 103 can be connected to a video recording/playback apparatus 21 (FTP reception device), video recording/playback apparatus 22 (DLNA reception device), and the like via the network.

The tuner unit 105 selects a broadcast signal of a designated channel, and inputs the selected broadcast signal to the recording/playback signal processing module 108. When video recording processing is designated, the recording/playback signal processing module 108 inputs video and audio signals corresponding to the broadcast signal to the disk drive unit 111 or HDD unit 112. The disk drive unit 111 records the input video and audio signals on an optical disk. Or the HDD unit 112 records the input video and audio signals on a hard disk. When playback processing is designated, the recording/playback signal processing module 108 outputs video and audio signals corresponding to the broadcast signal to a monitor M (with a loudspeaker) via the composition processing module 109.

An example of a content list display using a remote controller 102a will be described below. The signal light-receiving unit 102 receives a signal from the remote controller 102a, and notifies the control module 104 of information according to the received signal. For example, the signal light-receiving unit 102 receives a content list display instruction from the remote controller 102a, and notifies the control module 104 of this instruction. In response to this notification, the control module 104 acquires a list of contents recorded on an optical disk accessible by the disk drive unit 111 or that of contents recorded on the hard disk accessible by the HDD unit 112, and outputs content list display information for display content list information to the OSD control module 107. The OSD control module 107 outputs the content list display information to the composition processing module 109. Then, a video picture corresponding to the content list display information is displayed on the monitor M.

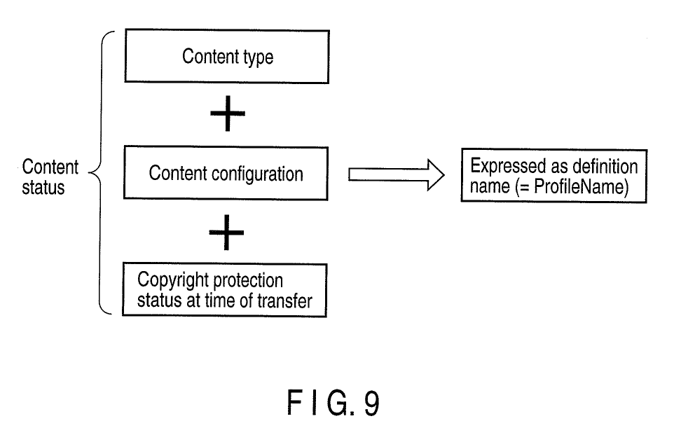

Support processing at the time of content transmission will be described below. Contents to be transmitted have various statuses. As information indicating a content status, “ProfileName” shown in FIG. 9 is available. This “ProfileName” indicates a content type (MPEG2/MPEG4/AVC, etc.), a content configuration (continuous content/discontinuous content), and a copyright protection status (DTCP) at the time of content transfer as a definition name. Using this “ProfileName”, a content to be handled can be easily specified. “DTCP_MPEG_TS_SD_JP_MPEG1_L2_T”, “MPEG_TTS_CP”, and the like are examples of “ProfileName”.

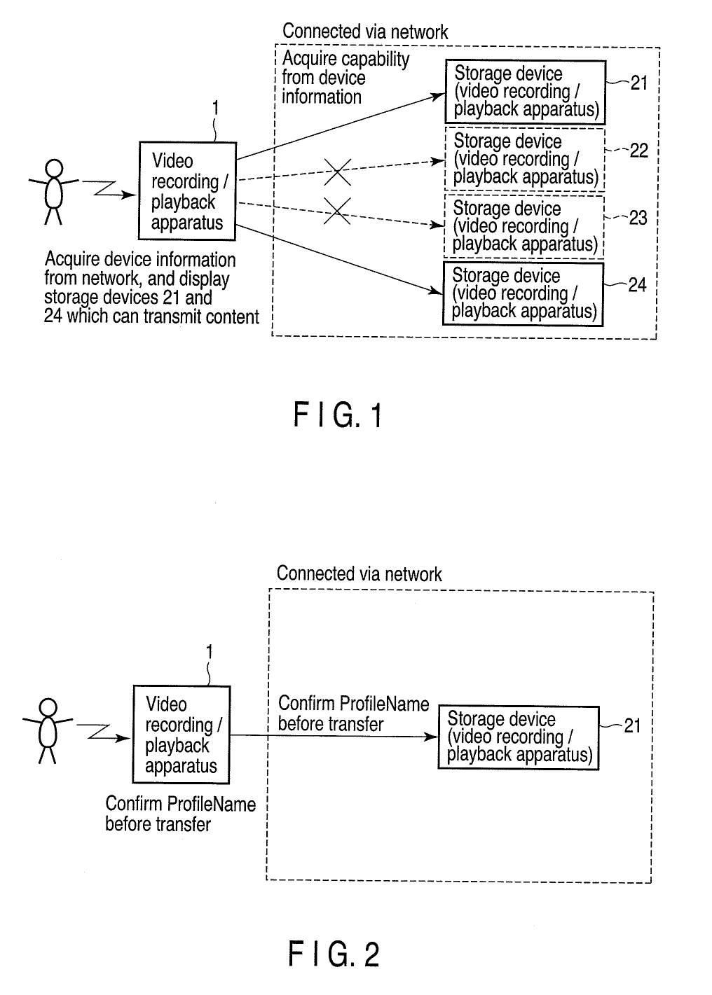

Storage devices connected to the video recording/playback apparatus 1 are not always compatible with every statuses of contents. For example, assume that the video recording/playback apparatus 1 is connected to storage devices 21, 22, 23, and 24 via the network, as shown in FIG. 1. Also, assume that storage devices 21 and 24 are compatible with a status of a first content stored in the video recording/playback apparatus 1, and storage devices 22 and 23 are incompatible with the status of the first content stored in the video recording/playback apparatus 1. In this case, when the video recording/playback apparatus 1 displays the connection states with storage devices 21, 22, 23, and 24 on the monitor M without any distinctions, the user may misunderstand that storage devices 21, 22, 23, and 24 are connected to the video recording/playback apparatus 1, the first content stored in the video recording/playback apparatus 1 can be transmitted to any one of storage devices 21, 22, 23, and 24, and any one of storage devices 21, 22, 23, and 24 can play it back. Hence, the video recording/playback apparatus 1 prevents such misunderstanding of the user by support processing at the time of content transmission to be described below.

For example, the network-connected device information acquisition module 1041 and connected device ProfileName detection module 1042 detect the statuses (content types, content configurations, copyright protection statuses, etc.) of contents compatible with (receivable by) storage devices 21, 22, 23, and 24 from storage devices 21, 22, 23, and 24. That is, these modules detect ProfileNames supported by storage devices 21, 22, 23, and 24. Furthermore, the transmittable ProfileName-incorporating device narrow-down module 1043 and narrow-down device list display & selection screen generation module 1046 output display information for display only connection states with storage devices 21 and 24 compatible with the first content (a content having a predetermined status). In this way, the monitor M displays only the connection states of storage devices 21 and 24 compatible with the first content. Alternatively, the transmittable ProfileName-incorporating device narrow-down module 1043 and narrow-down device list display & selection screen generation module 1046 output first display information for display the connection states with storage devices 21 and 24 compatible with the first content in a first display format (for example, a high-brightness display format), and second display information for display the connection states with storage devices 22 and 23 incompatible with the first content (a content having a predetermined status) in a second display format (for example, a low-brightness display format). Then, the monitor M displays the connection states with storage devices 21 and 24 compatible with the first content in the first display format, and those with storage devices 22 and 23 incompatible with the first content in the second display format. The user can easily and surely select a storage device compatible with a content having a predetermined status while viewing the display on the monitor M, and the control module 104 can transmit the content having the predetermined status to the selected storage device.

That is, when the user wants to copy or move a content stored in the video recording/playback apparatus 1 to a storage device connected to the video recording/playback apparatus 1, the video recording/playback apparatus 1 displays connections of storage devices so as to allow the user to understand the storage device suited to a transmission destination of the content. For example, the video recording/playback apparatus 1 may display only the connection of the storage device suited to a transmission destination of the content, or it may display the connection of the storage device suited to a transmission destination of the content in the first display format, and that of the storage device unsuited to a transmission destination of the content in the second display format. Then, the user can easily select the storage device suited to a transmission destination of the content. In other words, the user can be prevented from selecting the storage device unsuited to a transmission destination of the content.

Some examples of the support processing at the time of content transmission will be described below.

For example, the video recording/playback apparatus 1 outputs the display information for display the connection states with the storage devices compatible with at least one content of a plurality of contents as transmission candidates. Alternatively, the video recording/playback apparatus 1 outputs the first display information for display the connection states with the storage devices compatible with at least one content of a plurality of contents as transmission candidates in the first display format, and outputs the second display information for display the connection states with the storage devices incompatible with at least one content in the second display format.

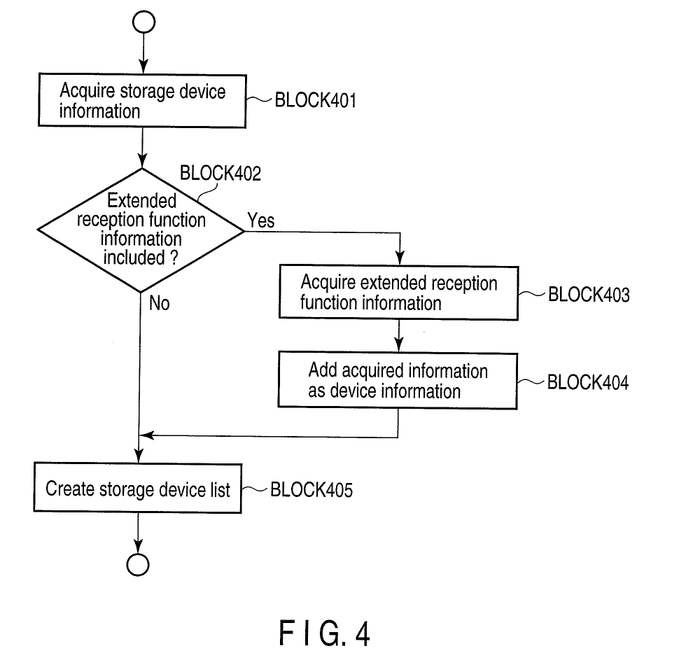

A practical description will be given with reference to FIG. 1. For example, assume that the video recording/playback apparatus 1 is connected to storage devices 21, 22, 23, and 24 via the network. In this case, as shown in FIG. 4, the network-connected device information acquisition module 1041 acquires storage device information from storage devices 21, 22, 23, and 24 (BLOCK 401). The module 1041 confirms whether each acquired storage device information includes extended reception function information selectable as a copy destination (BLOCK 402). If the extended reception function information is included (YES in BLOCK 402), the module 1041 acquires the extended reception function information (BLOCK 403), and adds the acquired extended reception function information as device information to create a storage device list (BLOCK 405).

The extended reception function information indicates that ProfileName exchange which supports transfer by other protocols is allowed in addition to that device definition information used to perform device detection on the network includes information (ProfileName) indicating permission of content transfer as storage device information.

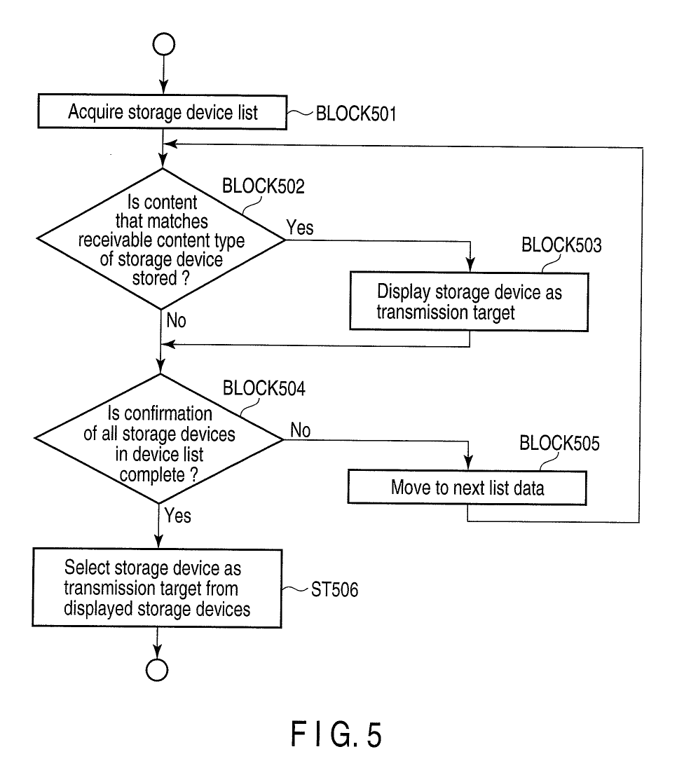

As shown in FIG. 5, the transmittable ProfileName-incorporating device narrow-down module 1043 acquires the storage device list (BLOCK 501), and confirms whether a content whose type matches a receivable content type of each storage device is stored (BLOCK 502). If the content whose type matches the receivable content type of the storage device is stored (YES in BLOCK 502), the narrow-down device list display & selection screen generation module 1046 outputs display information for display this storage device as a transmission target (BLOCK 503). The processes in BLOCK 502 and BLOCK 503 are applied to all storage devices in the device list (NO in BLOCK 504) (BLOCK 505). Then, the monitor M displays only storage devices compatible with the type of at least one content of a plurality of contents stored in the video recording/playback apparatus 1. The user can complete selection of an appropriate storage device by only selecting the storage device that he or she wants to set as a transmission destination from the displayed storage devices (BLOCK 506). In this manner, the video recording/playback apparatus 1 can display only storage devices that can be selected as a copy destination from a plurality of storage devices connected via the network on a user interface.

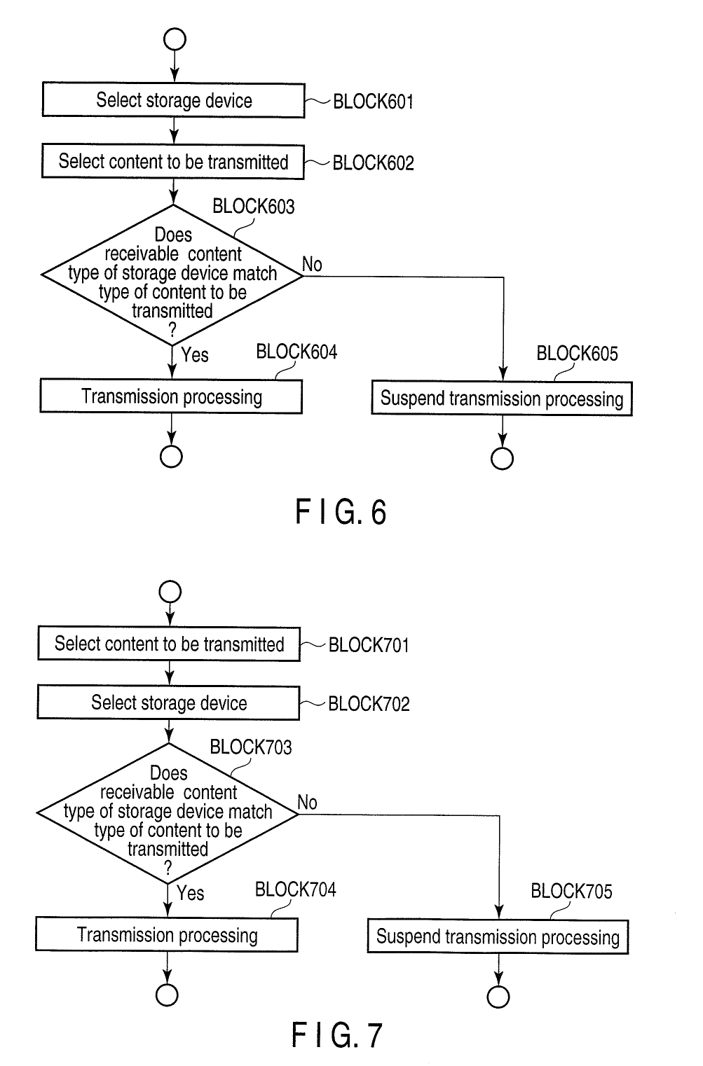

A case will be explained below with reference to FIGS. 2 and 6 wherein whether or not a storage device as a transmission destination supports the ProfileName that permits a content to be transmitted is confirmed before content transmission. FIG. 6 is a flowchart showing an example of support confirmation processing when the user selects a storage device and then selects a content to be transmitted. When the user selects a storage device as a transmission destination of a content (BLOCK 601) and then selects a content to be transmitted (BLOCK 602), the video file-selected transmission device ProfileName comparison/determination module 1047 confirms, prior to actual transmission of the content to be transmitted, whether or not a receivable content type of the selected storage device matches a type of the content to be transmitted (BLOCK 603). If the two types match (YES in BLOCK 603), the control module 104 transmits the content to be transmitted to the storage device selected as the transmission destination (BLOCK 604). If the two types do not match (NO in BLOCK 603), the control module 104 suspends transmission of the content to be transmitted (BLOCK 605).

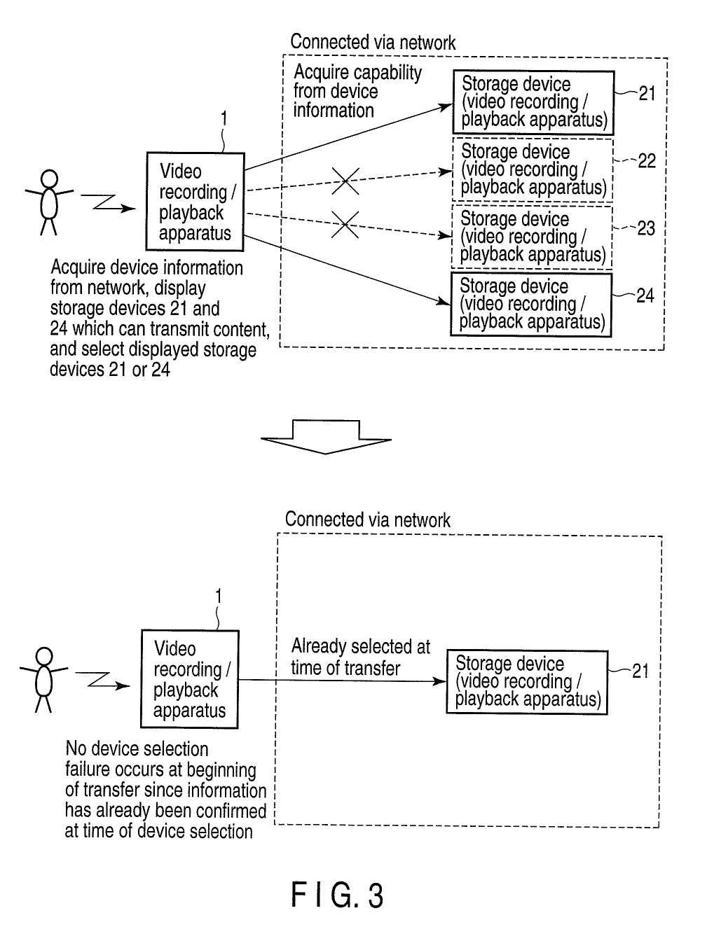

A case will be described below with reference to FIGS. 3 and 7 wherein whether or not a storage device as a transmission destination supports the ProfileName that permits a content to be transmitted is confirmed before content transmission. FIG. 7 is a flowchart showing an example of support confirmation processing executed when the user selects a content to be transmitted and then selects a storage device. When the user selects a content to be transmitted (BLOCK 701) and then selects a storage device as a transmission destination of the content (BLOCK 702), the video file-selected transmission device ProfileName comparison/determination module 1047 confirms, prior to actual transmission of the content to be transmitted, whether or not a receivable content type of the selected storage device matches a type of the content to be transmitted (BLOCK 703). If the two types match (YES in BLOCK 703), the control module 104 transmits the content to be transmitted to the storage device selected as the transmission destination (BLOCK 704). If the two types do not match (NO in BLOCK 703), the control module 104 suspends transmission of the content to be transmitted (BLOCK 705).

For example, when the user wants to copy a content from a DLNA client (video recording/playback apparatus 1) connected on the network to a DLNA server (video recording/playback apparatus 22), as shown in FIG. 8, the DLNA client detects a status of a content which is compatible with (can be received by) the DLNA server. When the DLNA server is compatible with a content having a predetermined status, the DLNA client displays the connection state of this DLNA server. Then, the user can surely select the DLNA server compatible with the content having the predetermined status, and can transmit the content having the predetermined status to the DLNA server.

Likewise, when the user wants to copy a content from an FTP client (video recording/playback apparatus 1) connected on the network to an FTP server (video recording/playback apparatus 21), the FTP client detects a status of a content which is compatible with (can be received by) the FTP server. When the FTP server is compatible with a content having a predetermined status, the FTP client displays the connection state of this FTP server. Then, the user can surely select the FTP server compatible with the content having the predetermined status, and can transmit the content having the predetermined status to the FTP server.

The video recording/playback apparatus 1 can also output display information for display only a storage device which supports the ProfileName of at least one content selected as a transmission target. Or the video recording/playback apparatus 1 may output first display information for display a storage device which supports the ProfileName of at least one content selected as a transmission target in the first display format, and may output second display information for display a storage device which does not support the ProfileName of at least one content selected as the transmission target in the second display format.

Then, operations other than current time operations can be guaranteed. That is, since storage devices compatible with the selected content are displayed, when the user selects the displayed storage device, transmission of the selected content is guaranteed. Hence, when the user does not directly operate the video recording/playback apparatus 1 at the time of a transfer operation like in a timer transfer mode, the selected content can be surely transmitted to the selected storage device.

The video recording/playback apparatus 1 can output display information for display only contents compatible with the ProfileName supported by a storage device selected as a transmission destination. Or the video recording/playback apparatus 1 can output first display information for display only contents compatible with the ProfileName supported by a storage device selected as a transmission destination in the first display mode and second display information for display contents incompatible with the ProfileName supported by the storage device selected as the transmission destination in the second display format.

Then, operations other than current time operations can be guaranteed. That is, since contents compatible with the selected storage device are displayed, when the user selects the displayed content, transmission of the selected content is guaranteed. Hence, when the user does not directly operate the video recording/playback apparatus 1 at the time of a transfer operation like in a timer transfer mode, the selected content can be surely transmitted to the selected storage device.

Also, the video recording/playback apparatus 1 can guarantee continuous transfer of a plurality of selected contents. The video recording/playback apparatus 1 outputs display information for display only a storage device compatible with all of the plurality of selected contents. Or the video recording/playback apparatus 1 outputs first display information for display a storage device compatible with all of the plurality of selected contents in the first display format, and second display information for display an incompatible display device in the second display format. Then, when the user selects the displayed storage device or the storage device displayed in the first display format, all of the plurality of selected contents can be surely transmitted. A transfer error at the time of continuous transfer of the plurality of selected contents can be prevented from being generated.

The video recording/playback apparatus 1 can guarantee continuous transfer of a plurality of selected contents after selection of a storage device. The video recording/playback apparatus 1 outputs display information for display only contents compatible with the selected storage device. Or the video recording/playback apparatus 1 outputs first display information for display contents compatible with the selected storage device in the first display format, and second display information for display incompatible contents in the second display format. Thus, when the user selects a plurality of displayed contents or a plurality of contents displayed in the first display format, all of the plurality of selected contents can be surely transmitted. Also, a transfer error at the time of continuous transfer of the plurality of selected contents can be prevented from being generated.

According to the aforementioned video recording/playback apparatus, the following effects can be obtained.

(1) Shorten Time for Copy/Move Destination Selection Operation

Since the video recording/playback apparatus 1 displays only selectable storage devices or identifiably displays selectable storage devices, even when a large number of storage devices are connected on the network, the user can easily and surely select a storage device suited to a transmission destination of a content.

(2) Shorten Transfer Error Detection Time Upon Copying/Moving

When the user selects a storage device while storage devices compatible with a content to be copied/moved are not narrowed down, an error may be generated upon transmission of the content to that storage device. In such case, the content transmission is suspended. However, this results in poor efficiency. Hence, the video recording/playback apparatus 1 confirms the ProfileNames supported by storage devices in advance, and confirms whether or not each storage device is suited to a transmission destination of a content. As a result, the aforementioned transmission error can be avoided.

(3) Copy/Move Device Selection in Continuous and Timer Operations is Guaranteed

The video recording/playback apparatus 1 confirms the type of a content to be copied/moved before copying/moving, and can exclude, in advance, suspension of a transfer operation due to mismatch between the type of a content compatible with the storage device and that of the content to be copied/moved. For this reason, the continuous transfer operation or timer transfer operation which is not operated by the user in real time can be guaranteed.

(4) Content Loss Prevention

When the user selects a storage device which is not suited to a move destination of a content and starts content movement, the content to be moved may often be lost or may be disabled to be played back. Since the video recording/playback apparatus 1 displays only storage devices suited to a move destination of the content or identifiably displays storage devices suited to the move destination of the content, selection of a storage device which is not suited to the move destination of the content can be prevented. As a result, the content to be moved can be prevented from being lost or being disabled to be played back.

While certain embodiments have been described, these embodiments have been presented by way of example only, and are not intended to limit the scope of the inventions. Indeed, the novel method and systems described herein may be embodied in a variety of other forms; furthermore, various omissions, substitutions and changes in the form of the methods and systems described herein may be made without departing from the spirit of the inventions. The various modules of the device described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. An information transmission apparatus comprising:
a connector configured to connect to at least one external device;
a detector configured to detect a status of at least one content compatible with the at least one connected external device;
an output module configured to output display information for displaying a connection state with at least one compatible external device compatible with the at least one content having the status, the at least one compatible external device being among the at least one connected external device; and
a transmitter configured to transmit a selected content to the at least one compatible external device displayed based on the display information.

2. The apparatus of claim 1, wherein the output module is configured to output the display information for displaying the connection state with the at least one compatible external device compatible with the status of the at least one content of a plurality of contents as transmission candidates.

3. The apparatus of claim 1, wherein the output module is configured to output first display information for displaying the connection state with the at least one compatible external device compatible with the status of the at least one content of a plurality of contents as transmission candidates, and to output second display information for displaying the connection state with at least one incompatible external device incompatible with the status of the at least one content of the plurality of contents.

4. The apparatus of claim 1, wherein the output module is configured to output the display information for displaying the connection state with the at least one compatible external device compatible with the status of at least one content selected as transmission targets from a plurality of contents as transmission candidates.

5. The apparatus of claim 1, wherein the output module is configured to output first display information for displaying the connection state with the at least one compatible external device compatible with the status of the at least one content selected as transmission target from a plurality of contents as transmission candidates, and to output second display information for displaying the connection state with at least one incompatible external device incompatible with the status of the at least one content selected as transmission target from the plurality of contents.

6. The apparatus of claim 1, wherein the output module is configured to output content display information for displaying at least one compatible content compatible with a selected external device, the at least one compatible content among a plurality of contents as transmission candidates.

7. The apparatus of claim 1, wherein the output module is configured to output first content display information for displaying at least one compatible content compatible with a selected external device, the at least one compatible content among a plurality of contents as transmission candidates, and to output second content display information for displaying at least one incompatible content incompatible with the selected external device, the at least one incompatible content among the plurality of contents.

8. The apparatus of claim 1, wherein the detector is configured to detect the status of the at least one content compatible with the connected external device from at least one information of a content type, a content configuration, and a copyright-protected status of the at least one content, which are compatible with the connected external device.

9. An information transmission method comprising:
connecting at least one external device;
detecting a status of at least one content compatible with the at least one connected external device;
outputting display information for displaying a connection state with at least one compatible external device compatible with the at least one content having the status, the at least one compatible external device being among the at least one connected external device; and
transmitting a selected content to the at least one external device displayed based on the display information.
